(19) United States
(12) Patent Application Publication
(10) Pub. No.: US 2015/0312067 A1
(43) Pub. Date: Oct. 29, 2015

(54) TRAINING SIGNALS FOR EGPRS MIMO TRANSMISSIONS

(71) Applicant: TELEFONAKTIEBOLAGET L M ERICSSON (PUBL), Stockholm (SE)

(72) Inventor: Miguel Lopez, Solna (SE)

(73) Assignee: Telefonaktiebolaget L M Ericsson (publ), Stockholm (SE)

(21) Appl. No.: 13/984,127

(22) PCT Filed: Jul. 19, 2013
(86) PCT No.: PCT/SE2013/050919

§ 371 Date: Aug. 7, 2013

Related U.S. Application Data
(60) Provisional application No. 61/684,939, filed on Aug. 20, 2012.

(51) Int. Cl. H04L 25/03

(52) U.S. Cl. CPC H04L 25/03891

(57) ABSTRACT

A network node for an EGPRS system, arranged to transmit bursts to a receiving node in the EGPRS system, where a burst comprises a training sequence with training information for use by the receiving node. The network node is arranged to use waveforms as said known training sequences, with the shape of the waveform as such conveying the training information. The waveforms are either digital waveforms or analogue waveforms.

### TECHNICAL FIELD

The present invention discloses novel training signals for EGPRS MIMO transmissions.

### BACKGROUND

The technology known as MIMO, Multiple Input, Multiple Output, is advantageous in wireless communications systems since MIMO offers the possibility of increased spectrum efficiency and increased peak rates as compared to non-MIMO technologies.

One issue of importance when designing MIMO systems for EGPRS and its derivates, e.g. EGPRS2, is the so called training sequences: FIG. 1 shows a prior art EGPRS burst, from which it can be seen that a burst comprises a training sequence in the middle of the burst, surrounded on both sides by data bits, tail bits and guard bits.

The training sequences are known sequences, i.e. known both to the transmitter and to the receiver, and are used by the receiver to perform channel estimation and synchronization, as well as, in the case when pre-coding is used, in order to estimate so called precoding matrices for the transmitter.

When designing training sequences for MIMO in EGPRS (and its derivatives, e.g. EPGRS2), it is naturally important to have training sequences which are as orthogonal as possible to each other. Prior art training sequences are lacking in these qualities when applied to MIMO EGPRS, particularly when applied to multi stream MIMO, i.e. MIMO with more than one data stream, a data stream also sometimes being referred to as a layer.

### SUMMARY

It is the object to obviate at least some of the above disadvantages and to provide network nodes for EGPRS MIMO with improved training sequences.

This object is obtained by means of a network node for an EGPRS system. The network node is arranged to transmit bursts to a receiving node in the EGPRS system, where a burst comprises a training sequence with training information for use by the receiving node. The network node is arranged to use known waveforms as the known training sequences, with the shape of the waveform as such conveying the training information.

Thus, as opposed to prior art training sequences which are sequences of symbols, the training sequences of the network node are waveforms, which, as will be elaborated upon below, opens for the possibility of using training sequences which exhibit better characteristics than prior art training sequences with regard to, for example, better orthogonality between the training sequences.

The waveforms which are used as training sequences can be different kinds of waveforms. In embodiments, the waveforms are digital waveforms or analogue waveforms.

The waveforms can be modulated or non-modulated.

In embodiments, the waveforms are chirps, either digital or analogue.

In embodiments, the waveforms comprise waveforms with constant amplitude.

In embodiments, the network node is arranged to transmit two or more data streams as MIMO data streams, and to use waveforms as training sequences for at least one of the MIMO data streams, with the shape of the waveform as such conveying the training information.

The object is also obtained by means of a network node for an EGPRS system. The network node is arranged to receive bursts from another node in the EGPRS system, where a burst comprises a known training sequence with training information for use by the network node.

The network node is arranged to receive, recognize and use waveforms as training sequences in the bursts from the other node and to find and extract the training information in the shape of the waveforms as such.

In embodiments, the network node is arranged to receive the waveforms as digital waveforms.

In embodiments, the network node is arranged to receive the waveforms as analogue waveforms.

In embodiments, the network node is arranged to receive the waveforms as non-modulated waveforms.

In embodiments, the network node is arranged to receive the waveforms as chirps.

In embodiments, the network node is arranged to receive the waveforms with constant amplitude.

In embodiments, the network node is arranged to use a training sequence which is a waveform as an indication that the other node is transmitting two or more data streams in MIMO mode.

The object is also obtained by means of a method for operating a network node in an EGPRS system. The method comprises transmitting bursts from the network node to a receiving node in the EGPRS system, and inserting into a burst for transmission a training sequence with training information for use by the receiving node. The method comprises the use of waveforms as training sequences, and using the shape of the waveform as such to convey the training information.

In embodiments of the method, the waveforms are digital waveforms.

In embodiments of the method, the waveforms are analogue waveforms.

In embodiments of the method, the waveforms are non-modulated.

In embodiments of the method, the waveforms are chirps.

In embodiments of the method, the waveforms comprise waveforms with constant amplitude.

In embodiments, the method comprises transmitting two or more data streams as MIMO data streams, and using waveforms as training sequences for at least one of the MIMO data streams, with the shape of the waveform as such conveying the training information.

The object is also obtained by means of a method for operating a network node in an EGPRS system. The method comprises receiving bursts from another node in the EGPRS system, where a burst comprises a training sequence with training information for use by the network node, and the method comprises recognizing and using waveforms as training sequences in the bursts from the other node, and finding and extracting the training information in the shape of the waveforms as such.

In embodiments of the method, the waveforms are received as digital waveforms.

In embodiments of the method, the waveforms are received as analogue waveforms.

In embodiments of the method, the waveforms are received as non-modulated waveforms.

In embodiments of the method, the waveforms are received as chirps.

In embodiments of the method, the waveforms are received as waveforms with constant amplitude.

In embodiments of the method, a burst with a training sequence which is a waveform is used as an indication that the other node is transmitting two or more data streams in MIMO mode.

### BRIEF DESCRIPTION OF THE DRAWINGS

The invention will be described in more detail in the following, with reference to the appended drawings, in which

FIG. 1 shows a prior art EGPRS burst, and

FIG. 2 shows a flow chart of prior art method for forming and transmitting an EGPRS burst, and

FIG. 3 shows a flow chart of a first embodiment of a method for forming and transmitting an EGPRS burst, and

FIG. 4 shows a flow chart of second embodiment of a method for forming and transmitting an EGPRS burst, and

FIG. 5 shows a flow chart of third embodiment of a method for forming and transmitting an EGPRS burst, and

FIG. 6 shows the autocorrelation of two digital chirps, and

FIG. 7 shows a performance chart with a comparison to VAMOS, and

FIG. 8 shows a flow chart of a method for blind detection of MIMO/non-MIMO transmissions, and

FIG. 9 shows an I-Q plot of a digital chirp, and

FIG. 10 shows a block diagram of a network node, and

FIG. 11 shows a flow chart of a method for EGPRS MIMO transmission and

FIG. 12 shows a flow chart of a method for EGPRS MIMO reception.

### DETAILED DESCRIPTION

Embodiments of the present invention will be described more fully hereinafter with reference to the accompanying drawings, in which embodiments of the invention are shown. The invention may, however, be embodied in many different forms and should not be construed as being limited to the embodiments set forth herein. Like numbers in the drawings refer to like elements throughout.

The terminology used herein is for the purpose of describing particular embodiments only, and is not intended to limit the invention.

In the following, techniques will be described as being EGPRS techniques. EGPRS is here used to denote EGPRS and all of its derivatives, such as e.g. EPGRPS 2. In addition, the techniques described herein can be used both in the uplink and in the downlink directions, i.e. both in a Mobile Terminal and in a Radio Base Station.

For the sake of clarity and completeness, prior art EGPRS training sequences and modulation will first be briefly discussed, as background information.

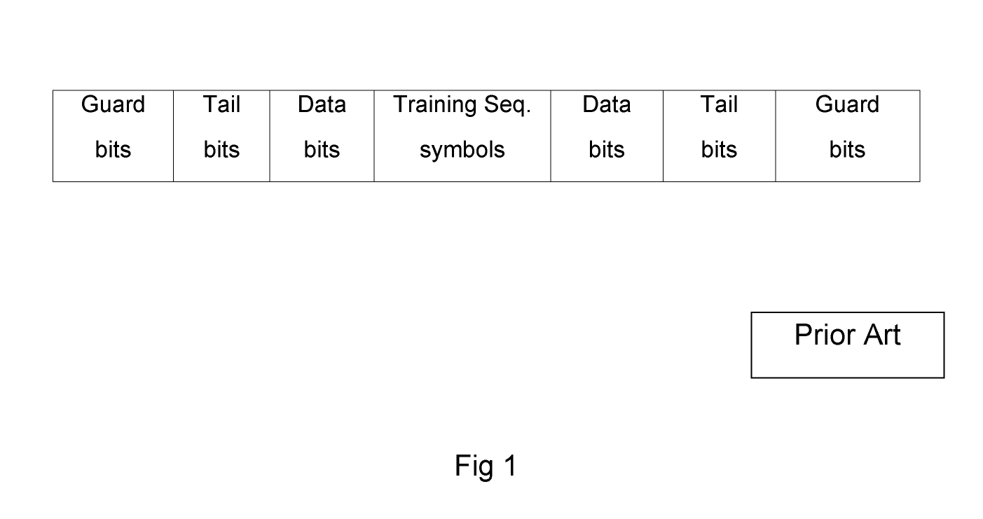

FIG. 1 shows an EGPRS burst (which is part of an EGPRS radio block, where one radio block at present comprises four bursts. One EGRPS radio block can carry one or more RLC data blocks.)

As shown in FIG. 1, an EGPRS burst comprises guard bits at both ends (“left” and “right” guard) as well as tail bits adjacent to the guard bits on both sides, and data bits adjacent to the tail bits on both sides. In the centre of the burst, there is a training sequence, comprised of known symbols, i.e. known to both the receiver and the transmitter. The use and purpose of the training sequence has been described in the previous section of this text and will therefore not be described here again.

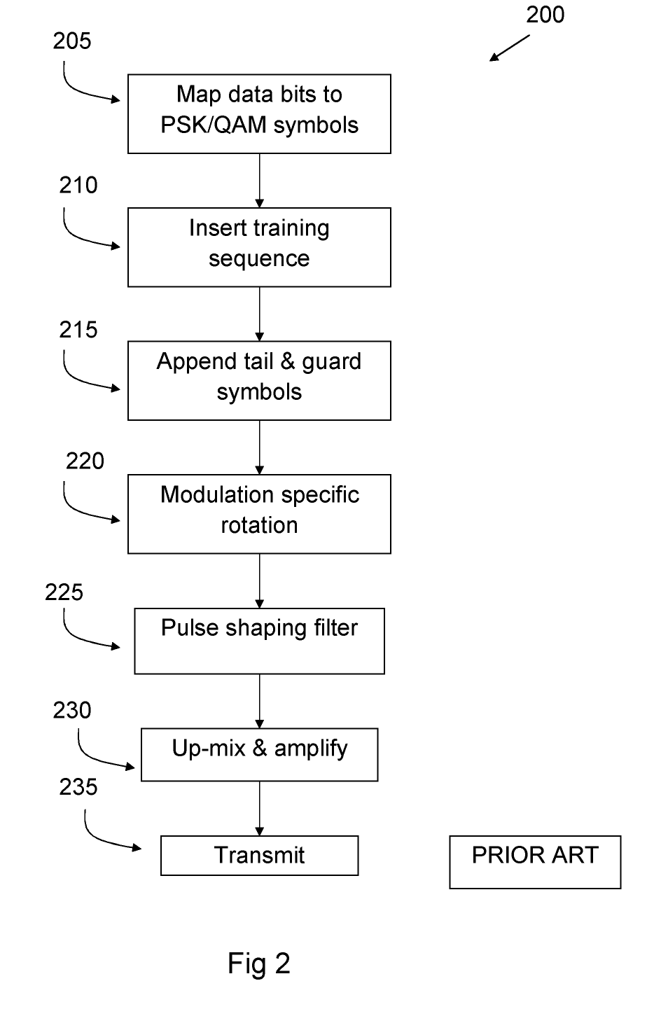

FIG. 2 shows a flow chart of a prior art EGPRS method 200 for forming and transmitting a burst. It should be pointed out that the steps shown in FIG. 2 can be performed in other orders as well while achieving the same end result.

In step 205, data bits which are to be transmitted in the burst are mapped to symbols of the modulation to be used, e.g. PSK or QAM. Following this, the training sequence is inserted into the burst in step 210.

In step 215, the tail and guard symbols shown in FIG. 1 are inserted into the burst. In step 220, where applicable and desirable, the burst is given a modulation specific rotation angle which here is denoted as 0. In step 225, the burst is passed through a pulse shaping filter, and in step 230, the burst is converted to the desired transmit frequency (“up mix”) and amplified, if necessary. In step 235, the burst is transmitted via a transmit antenna.

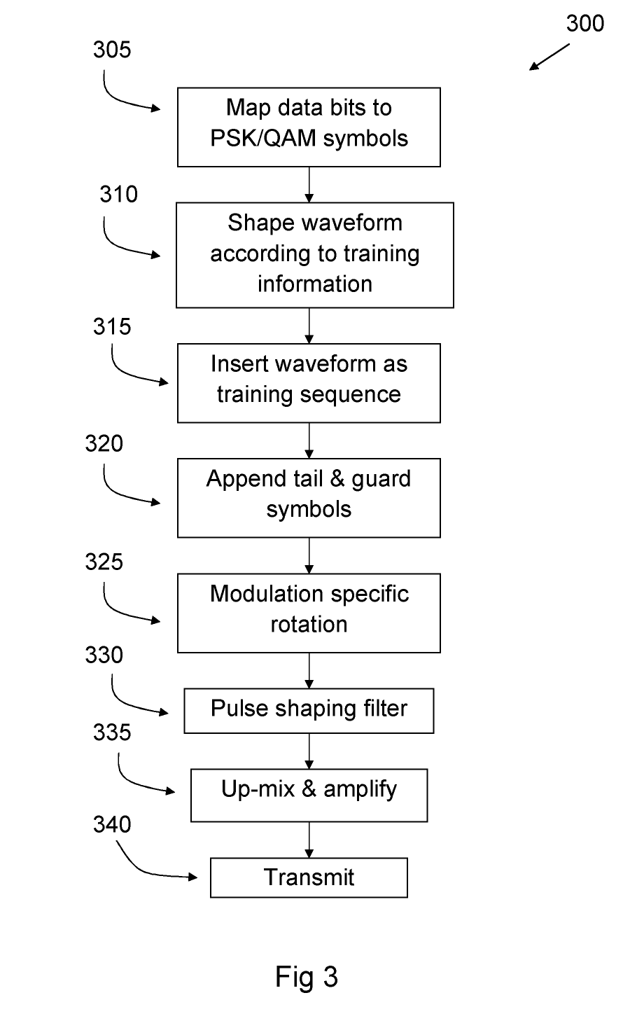

FIG. 3 shows a flow chart of a first embodiment of a method for forming and transmitting an EGPRS burst. Steps which, although sometimes shown with different numbers in FIG. 3, have been described previously will not be described again, in the interest of brevity. According to the method 300, waveforms which comprise training information in the shape as such of the waveforms are used in the method 300. Thus, in step 310, the waveform which is to be used for the training sequence in this particular burst is formed, according to the training information which is to be conveyed. Although formed in this step, the waveform is one of a variety of waveforms which are known both to the transmitter which is to transmit the burst and to the receiver for which the burst is intended.

Once the desired waveform is shaped in the proper manner in step 310, it is inserted into the burst to be transmitted as the training sequence of the burst, step 315.

Regarding the waveforms which are used as training sequences, the waveforms can vary in a large number of ways, for example although the waveforms are suitably digital, analogue waveforms could also be used.

The waveforms can be either modulated or non-modulated. The term “modulated” is here is used in the following manner when it comes to digital waveforms: information bits are “mapped” to symbols of a certain modulation, e-.g. M-PSK or M-QAM, so that an non-modulated digital waveform is in this sense a waveform which is obtained without digital information bits having been mapped to a constellation of complex modulation symbols.

Suitably but not necessarily, the waveforms which are used as training sequences have constant amplitude.

In one particular embodiment, the waveforms which are used as training sequences are so called chirps, either analogue or digital. An analogue chirp is a signal with constant amplitude, but with a constant variation (increasing or decreasing) in its frequency over the duration of the chirp.

A digital chirp is a signal x(n) of the form

x_{θ}(n)=exp(jθ·n·f(n)),

where f(n) is an increasing function. Chirps are signals whose frequency increases with time. In one embodiment of the invention, the linear function

$$f ( n ) = \frac{n}{2}$$

is chosen, although many other choices of f(n) are possible, such as f(n)= ω̅·n^{χ}, where ω̅, χ are design parameters.

A digital chirp of the form

$${x}_{θ} ( n ) = exp ( j θ \cdot \frac{{n}^{2}}{2} ) \qquad ( 1 )$$

is called a linear digital chirp because its frequency increases linearly with time. Digital chirps have the following properties.
A digital chirp has constant amplitude,
It is possible to select different angles θ,φ such that the digital chirps x_{θ}(n) and x_{φ}(n) have good auto-correlation properties (white noise-like) and good cross-correlation properties (they are orthogonal).

As has been explained, analogue or digital chirps can be used as training sequences, i.e. in lieu of the prior art training sequence symbols, digital chirps are inserted in the middle of a burst (“the mid-amble of the burst”) in order to convey training information.

The training sequences, as mentioned, are used at the receiver side for synchronization and channel estimation.

Although a digital chirp can be expressed as in equation (1) above, a rotation by an angle Θ can be added to the digital chirp in order to convey an additional signal or message to the receiver, so that, for example, the rotation angle Θ may be used by the transmitter in order send a signal to the receiver, and different rotation angles Θ correspond to different messages. One example of a message could be to signal a complex constellation used to modulate the payload. For example, one value of the angle Θ would indicate 8PSK while another value would indicate 16QAM.

Such a “modified” digital chirp could then be written as

$${x}_{θ} ( n ) = exp ( j θ \cdot \frac{{n}^{2}}{2} ) \cdot exp ( j Θ \cdot n ) = exp ( j [ θ \cdot \frac{{n}^{2}}{2} + Θ \cdot n ] )$$

Suitably, the set of possible angles {Θ₁, . . . , Θ_{M}} is finite and known by the receiver. For example, a first angle Θ₁ may be used by the transmitter to signal that MIMO transmission mode 1 has been used, while a second angle Θ₂ means that MIMO transmission mode 2 has been used. Here, “MIMO mode 1” and “MIMO mode 2” are used to refer to different modulations, coding, pre-coding or other possible characteristics of the physical layer.

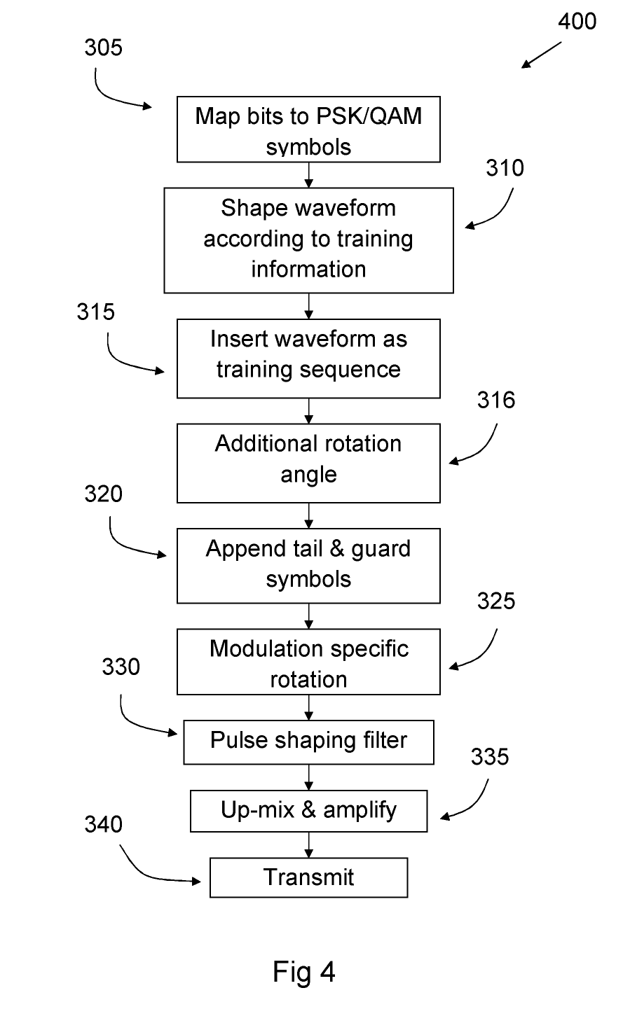

FIG. 4 shows a flow chart of a method 400 similar to the method of FIG. 3, although the method 400 also comprises the step 316 of the rotation described above, shown as “additional rotation angle”.

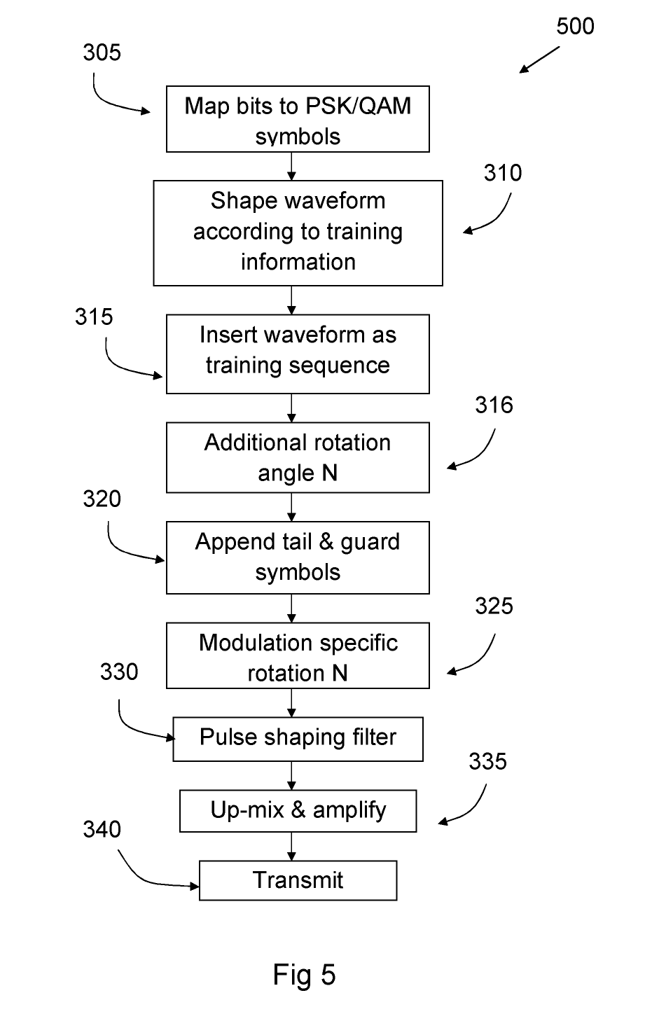

Since the use of waveforms as training sequences is well suited for use in EGPRS MIMO systems, such training sequences can by definition be used when transmitting a plurality N (integer) of data streams, also sometimes referred to as layers. In such cases, the rotation angle Θ of the chirp could be varied between the different data streams, so that there could be N different such rotations, one for each data stream. In addition, in connection with the description of FIG. 3, a modulation specific rotation angle has also been described, see step 325 in FIG. 3. A flowchart of a method 500 is shown in FIG. 5, for transmitting N data streams as EGPRS MIMO data streams. The flowchart in FIG. 5 is similar to the one in FIG. 4, although steps 316 and 325c have been amended to show that there are N different data streams, and that the angles mentioned above are varied for each data stream.

The description has so far dealt mainly with the transmission of bursts for EGPRS, in particular EGPRS MIMO. Turning now to the receiving end of such EGPRS MIMO bursts, this can be explained as follows, using L to denote the length of the discrete equivalent channel:

Using the described bursts in a 2×2 MIMO EGPRS system, the received signal over the training sequence can be described by a linear model of the form (after de-rotation in the transmitter of the modulation specific rotation, step 325 of FIGS. 3-5):

Y=X_{θ}·H+X_{φ}·G+E,

Where Y is the received signal, X_{θ} and X_{φ} are the two data streams rotated by angles Θ₁ and Θ₂ respectively, and H and G are the L-tap channels for the respective data streams.

The two data streams X_{θ} and X_{φ} can also be written as:

$${X}_{θ} = [ \begin{matrix}{x}_{θ} ( L ) & … & {x}_{θ} ( 1 ) \\ ⋮ & ⋱ & ⋮ \\ {x}_{θ} ( N ) & … & {x}_{θ} ( N - L + 1 )\end{matrix} ] , \\ and$$

$${X}_{ϕ} = [ \begin{matrix}{x}_{ϕ} ( L ) & … & {x}_{ϕ} ( 1 ) \\ ⋮ & ⋱ & ⋮ \\ {x}_{ϕ} ( N ) & … & {x}_{ϕ} ( N - L + 1 )\end{matrix} ] .$$

As an example, let θ=3.9983 radians and let φ=1.1423 radians, L=5, Θ₁=Θ₂=0, and N=26. The two digital chirp sequences

$${x}_{θ} ( n ) = exp ( j θ \cdot \frac{{n}^{2}}{2} ) , n = 1 , … , N , \\ and$$

$${x}_{ϕ} ( n ) = exp ( j ϕ \cdot \frac{{n}^{2}}{2} ) , n = 1 , … , N ,$$

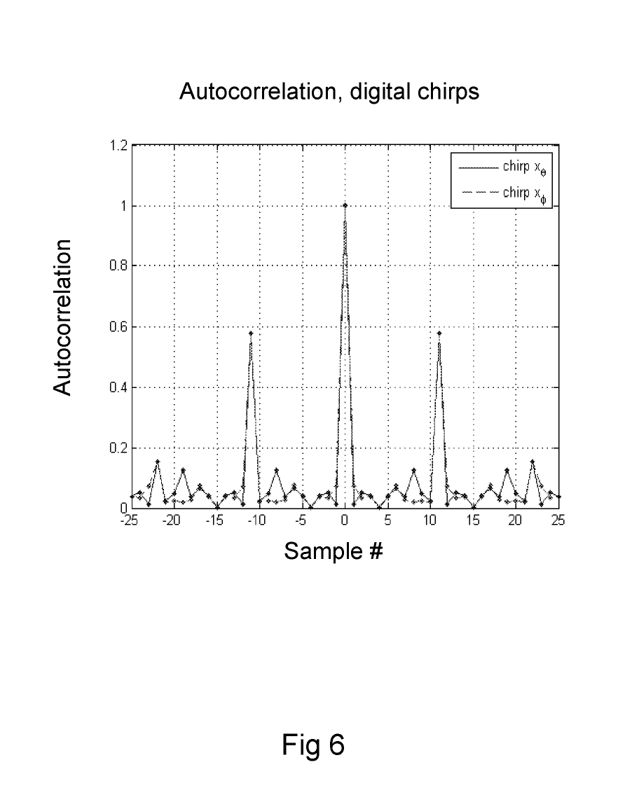

will then exhibit good autocorrelation and cross-correlation properties. FIG. 6 shows the autocorrelations of these two chirps.

In addition, it can be shown that the cross-correlations of these two chirps are substantially smaller than the cross-correlations among any pair of legacy training sequences. The “legacy training sequences” are the existing GSM and EGPRS training sequences used at present.

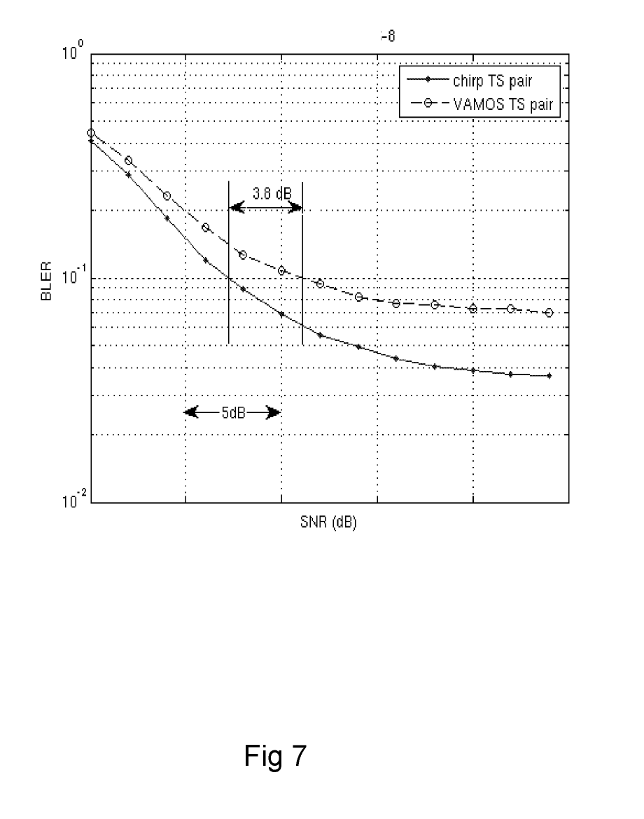

FIG. 7 shows the simulation results for one of the data streams in a 2×2 MIMO system based on two 8PSK modulated data streams. Each data stream has been independently modulated and coded according to EGPRS MCS-8. In the reference system (dashed line), the best pair of traditional prior art training sequences has been used. Using an embodiment of the invention, a new MIMO system has been implemented, in which the sequences of training symbols have been substituted by digital chirps. The digital chirps shown above, i.e. with θ=3.9983 radians, φ=1.1423 have been used. The solid line shows the results using this embodiment. The receiver algorithms which have been used are identical in both cases, so that the difference in performance is due entirely to the improved orthogonality provided by the digital chirps. A substantial gain of 3.8 dB at 10% BLER (Block Error Ratio) can be seen between the two cases, i.e. prior art training sequences and waveform training sequences, here in the form of digital chirps.

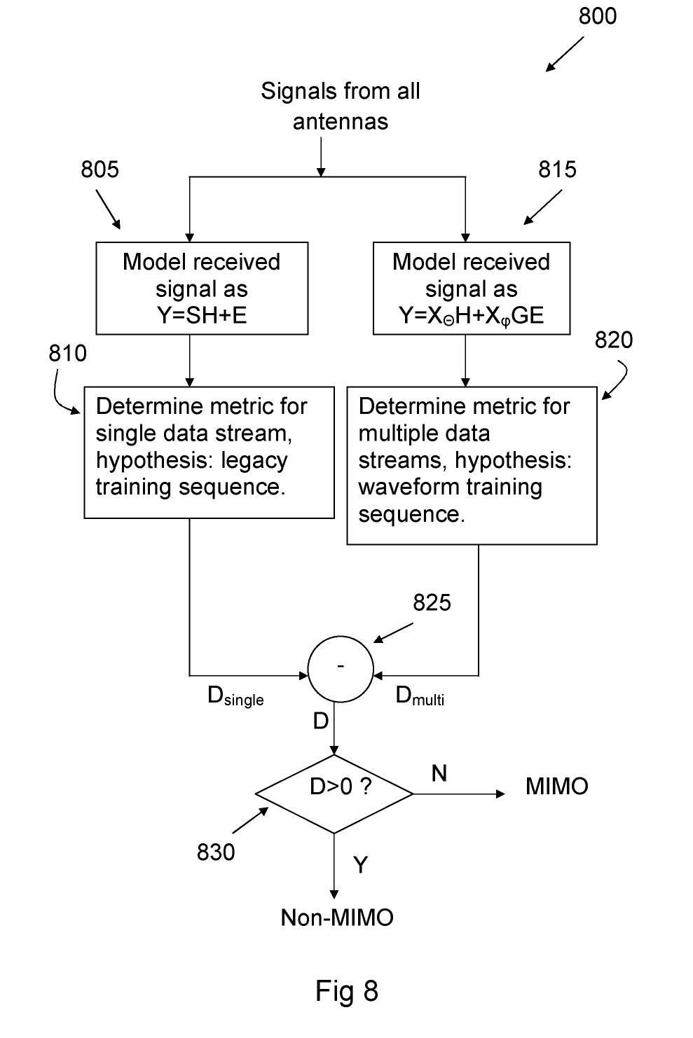

Remaining on the receiver side, the receiver needs to know if the received signal from the transmitter is a MIMO transmission or not. The technique with waveforms as training information can be used for this purpose as well: transmissions which consist of more than one data stream can be made with waveforms as training sequences, while transmissions which consist of only one data stream are made with “traditional” training sequences. In this manner, the receiver can perform “blind detection” of transmissions with one or with more than one data stream. A flowchart of a method 800 for such blind detection for use in an EGPRS receiver is shown in FIG. 8:

In order to perform the blind detection, the receiver makes two hypotheses, and applies them to the signals received by all antennas. The first hypothesis, shown in step 805 is that the received signal(s) consist of one layer. Under this hypothesis, a blind detection metric D_single is determined. A large value of the statistic D_single means that single layer transmission is very likely. The second hypothesis, shown in step 815, is that the received signal(s) consist of 2 layers. A blind detection metric D_multi is determined under this hypothesis. A large value of D_multi means that two-layer transmission is very likely. The use of the two hypotheses of steps 805 and 815 can also be seen as determining two signal models:

Y=S·H+E Single layer transmission. 1.

Y=X_{θ}·H+X_{φ}·G+E Two-layer transmission. 2.

As shown in step 825, the difference D between D_multi and D_single is determined, and if D is negative, then the receiver determines that the received signals(s) are the result of MIMO transmissions, while, if D is positive, then the receiver determines that the received signals(s) are the result of non-MIMO transmissions. In this way, determining if the received signals(s) are the result of MIMO transmissions or not enables the receiver to use the proper demodulation techniques for the received signal(s).

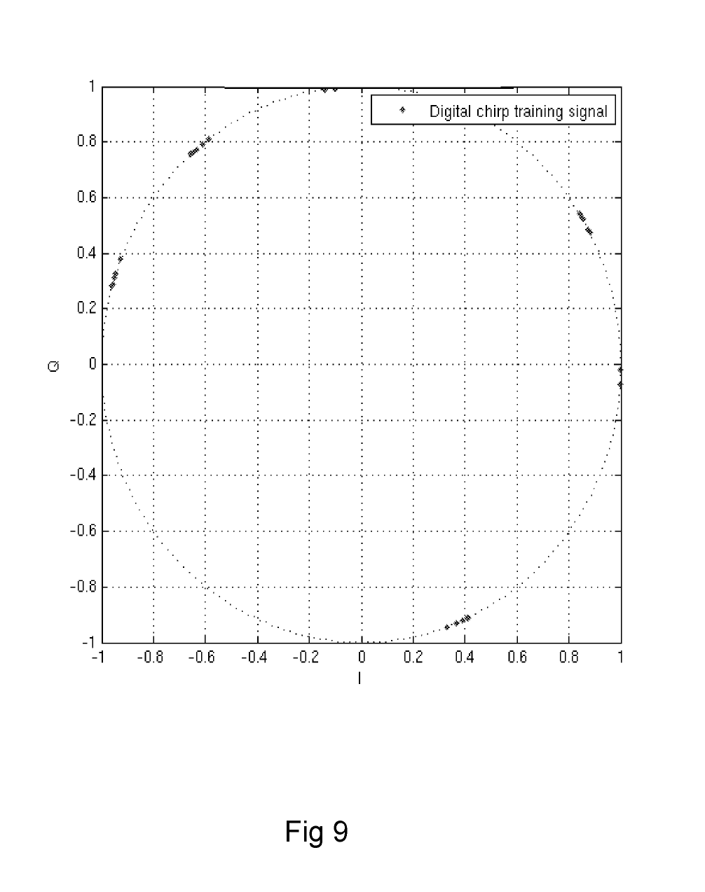

FIG. 9 shows an I-Q plot of a digital chirp.

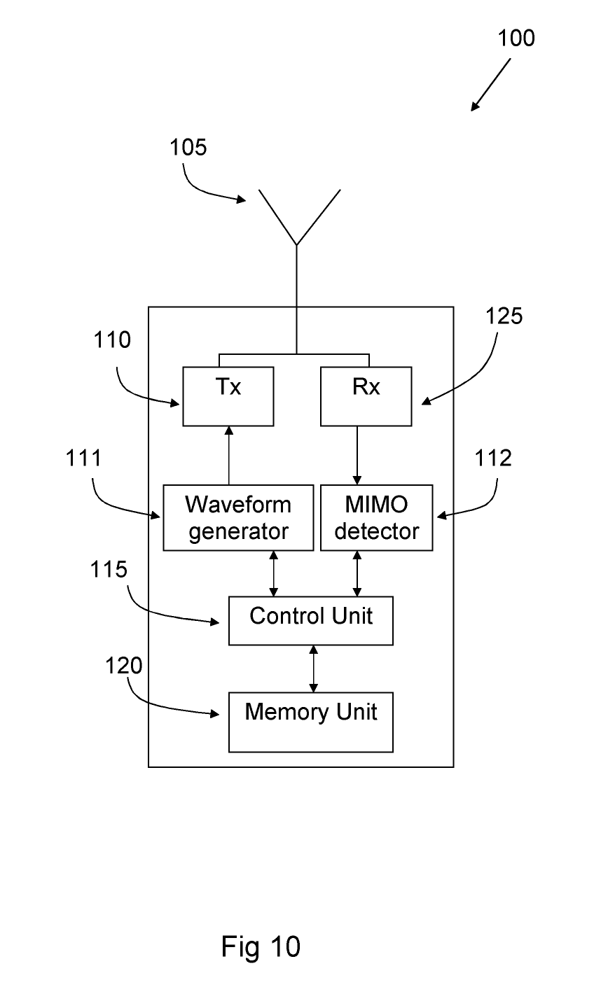

FIG. 10 shows a block diagram of a network node 100 for use with the training sequences described above. The network node 100 is shown as being both a transmitting and a receiving node, although these two functionalities can also be divided into two separate nodes. As mentioned, the network node 100 can be either a Mobile Terminal or a Radio Base Station.

As shown in FIG. 10, the network node 100 comprises an antenna unit 105, which serves both as a transmit and a receive antenna. The network node further comprises a transmit unit 110, connected to a waveform generator 111. The waveform generator 111 serves to form the waveforms which are used as training sequences in the manner described above, and has as its function controlled by a control unit 115. The control unit 115 also controls the overall function of the network node 100. As mentioned, there is a transmit unit 110 comprised in the network node 100, which also comprises the pulse-shaping filter described in connection to FIGS. 3-5, and to perform the up-mixing and amplification shown in these figures, as well as the actual transmission, via the antenna unit 105. There is also a memory unit 120 comprised in the network node, which, for example, holds information on the shape of the waveforms for use as training sequences.

The network node 100 also comprises a receive unit 125 connected to the antenna unit 105. The receive unit 125 performs such tasks as down-mixing (i.e. the opposite of the up-mixing), and is connected to a MIMO detector 112, which is also comprised in the network node 100. The MIMO detector 112 serves to perform “blind detection” of MIMO transmissions, as described above in connection to FIG. 8. The MIMO detector 112 is also connected to the control unit 115, which controls the function of the MIMO detector and which receives information from it regarding whether received transmissions are MIMO transmission or not.

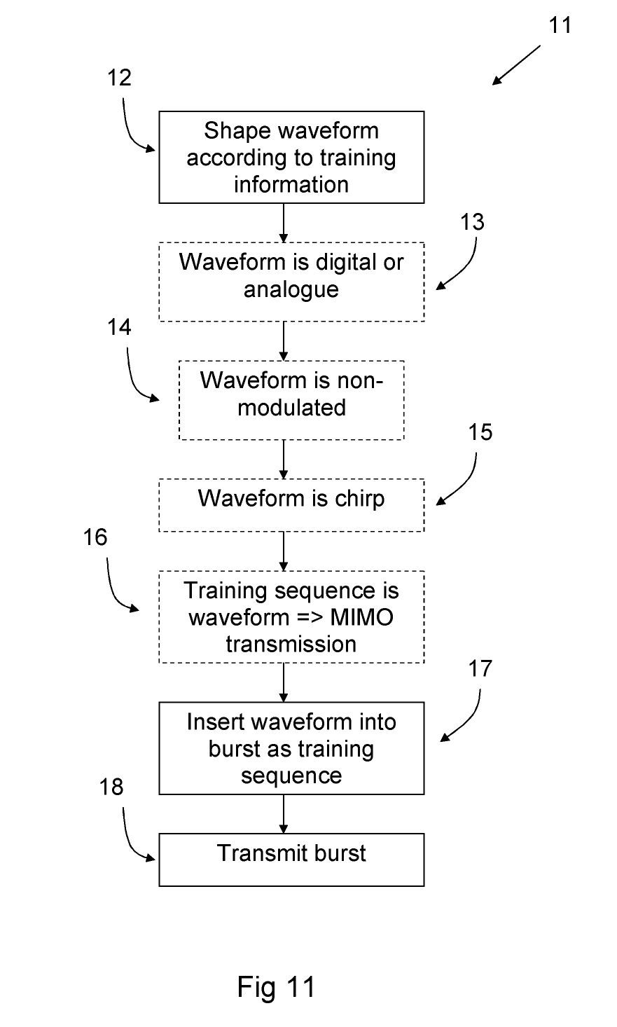

FIG. 11 shows a flow chart of a method 11 for operating a network node in an EGPRS system. Steps which are options or alternatives are indicated with dashed lines.

The method 11 comprises the use of waveforms as training sequences in bursts which are transmitted to a receiving node in the EGPRS system, and using the shape of the waveform as such to convey the training information.

As shown in step 12, the waveform is shaped according to the training information which it is desired to convey to the receiving node.

As shown in steps 13 and 14, in embodiments, the waveform can be digital or analogue, and as shown in step 15, in embodiments, the waveform can be a chirp.

In embodiments, the waveforms which are used as training sequences comprise waveforms with constant amplitude.

As shown in step 16, in embodiments, the use of a waveform as a training sequence in a burst can be used to signal to the receiving node that the network node is using MIMO transmissions.

In the MIMO case, the network node is used to transmit two or more data streams as MIMO data streams, and waveforms are used as training sequences for at least one of the MIMO data streams, with the shape of the waveform as such conveying the training information for the at least one MIMO data stream.

As shown in step 17, the shaped waveform is inserted into a burst as a training sequence, and the burst is then transmitted, step 18.

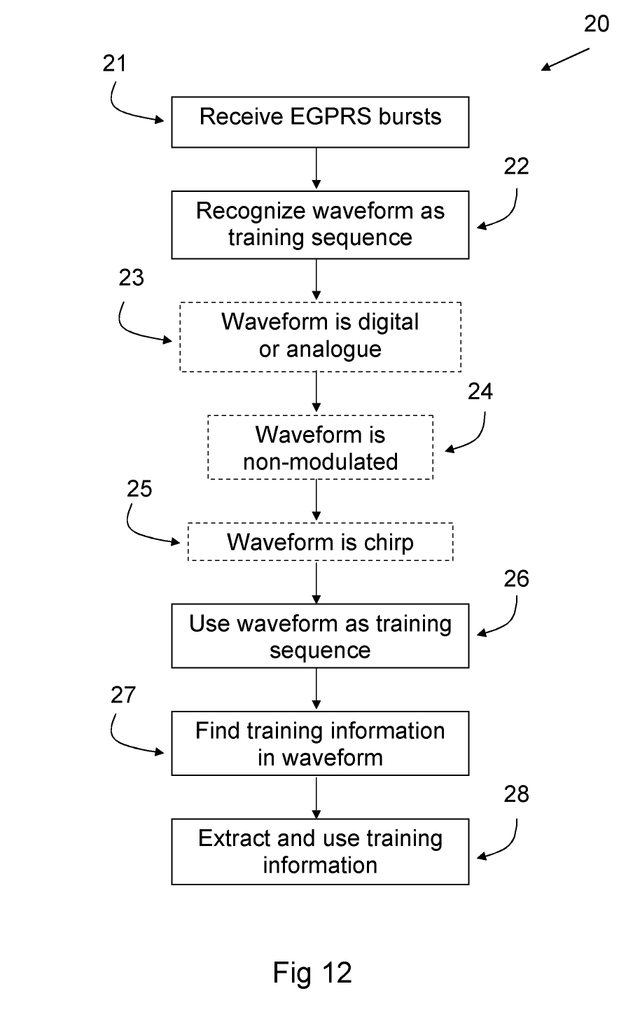

FIG. 12 shows a flow chart of a method 20 for operating a network node in an EGPRS system. Steps which are options or alternatives are shown with dashed lines in FIG. 12.

As shown in step 21, the method 20 comprises receiving bursts from another node in the EGPRS system. A burst comprises a training sequence with training information for use by the network node, and as indicated in step 22, the method 20 comprises recognizing a waveform in the burst.

As indicated in step 23, in embodiments of the method 20, the waveform can be analogue or digital, and as indicated in step 24, in embodiments of the method 20, the waveform can be non-modulated. As indicated in step 25, in embodiments of the method 20, the waveform can be a chirp. In embodiments of the method 20, the waveforms are received as waveforms with constant amplitude.

The waveform which is recognized in step 22 is used, step 26, as a training sequence in the bursts from the other node, and as shown in steps 26 and 27, the method 20 comprises finding and extracting the training information in the shape of the waveforms as such.

In embodiments of the method 20, a burst with a training sequence which is a waveform is used as an indication that the other node is transmitting two or more data streams in MIMO mode.

Above, the use of two data streams has been discussed in connection with the use of the training sequences for EGPRS MIMO bursts. Naturally, the same principle can be extended to a larger number of data streams than two in EGPRS MIMO mode.

In addition, the use of waveforms as training sequences has been exemplified by digital chirps. Naturally, other waveforms can also be used, for example other training sequences of the form x_{ω}(n)=exp (jωₙ), n=1, . . . N, may also be used as training signals for each layer. No constraint is imposed upon the angles ωₙ, any set of real numbers is feasible. Therefore, the complex numbers x_{ω}(n) need not belong to a pre-defined symbol constellation. The only requirement is that the angles ωₙ, n=1 . . . N are known by the receiver. This gives added flexibility to the design of the training signal, so that the data streams can be made orthogonal to each other over the training signal. Such training signals could be generated by taking arbitrary sequences of angles ωₙ, ω̅ₙ, n=1 . . . N, and determining

x_{ω}(n)=exp(jωₙ),n=1 . . . N, (3)

x _{ω̅}(n)=exp(jωₙ),n=1 . . . N, (4)

The angles ωₙ, ω̅ₙ are selected so that the signals given by (3) and (4) have good autocorrelation and cross-correlation properties. It is also possible to add an additional rotation angle to the training signal, in order to signal information implicitly to the receiver. For example different rotation angles may indicate the modulation used for the data, such as 8PSK or 16QAM.

Finally, it is possible to extend the methodology for blind detection of the training sequences from digital chirps to arbitrary training signals, such as those given by (3) and (4).

Embodiments of the invention are described with reference to the drawings, such as block diagrams and/or flowcharts. It is understood that several blocks of the block diagrams and/or flowchart illustrations, and combinations of blocks in the block diagrams and/or flowchart illustrations, can be implemented by computer program instructions. Such computer program instructions may be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

In some implementations, the functions or steps noted in the blocks may occur out of the order noted in the operational illustrations. For example, two blocks shown in succession may in fact be executed substantially concurrently or the blocks may sometimes be executed in the reverse order, depending upon the functionality/acts involved.

In the drawings and specification, there have been disclosed exemplary embodiments of the invention. However, many variations and modifications can be made to these embodiments without substantially departing from the principles of the present invention. Accordingly, although specific terms are employed, they are used in a generic and descriptive sense only and not for purposes of limitation.

The invention is not limited to the examples of embodiments described above and shown in the drawings, but may be freely varied within the scope of the appended claims.

1. A network node for an EGPRS system, the network node being arranged to transmit bursts to a receiving node in the EGPRS system, where a burst comprises a training sequence with training information for use by the receiving node, the network node being characterized in that it is arranged to use waveforms as said training sequences, with the shape of the waveform as such conveying the training information.

2. The network node of claim 1, in which said waveforms are digital waveforms.

3. The network node of claim 1, in which said waveforms are analogue waveforms.

4. The network node of claim 1, in which said waveforms are non-modulated.

5. The network node of claim 1, in which said waveforms are chirps.

6. The network node of claim 1, in which said waveforms comprise waveforms with constant amplitude.

7. The network node of claim 1, being arranged to transmit two or more data streams as MIMO data streams, and to use waveforms as training sequences for at least one of the MIMO data streams with the shape of the waveform as such conveying the training information.

8. A network node for an EGPRS system, the network node being arranged to receive bursts from another node in the EGPRS system, where a burst comprises a training sequence with training information for use by the network node, the network node being characterized in that it is arranged to receive, recognize and use waveforms as training sequences in the bursts from the other node and to find and extract the training information in the shape of the waveforms as such.

9. The network node of claim 9, being arranged to receive said waveforms as digital waveforms.

10. The network node of claim 8, being arranged to receive said waveforms as analogue waveforms.

11. The network node of claim 8, being arranged to receive said waveforms as non-modulated waveforms.

12. The network node of claim 8, being arranged to receive said waveforms as chirps.

13. The network node of claim 8, being arranged to receive said waveforms with constant amplitude.

14. The network node of claim 8, being arranged to use a training sequence which is a waveform as an indication that the other node is transmitting two or more data streams in MIMO mode.

15. A method for operating a network node in an EGPRS system, the method comprising transmitting bursts from the network node to a receiving node in the EGPRS system, and inserting into a burst for transmission a training sequence with training information for use by the receiving node, the method being characterized in that it comprises the use of waveforms as said training sequences, and using the shape of the waveform as such to convey the training information.

16. The method of claim 15, according to which said waveforms are digital waveforms.

17. The method of claim 15, according to which said waveforms are analogue waveforms.

18. The method of claim 15, according to which said waveforms are non-modulated.

19. The method of claim 15, according to which said waveforms are chirps.

20. The method of claim 15, according to which said waveforms comprise waveforms with constant amplitude.

21. The method of claim 15, comprising transmitting two or more data streams as MIMO data streams, and using waveforms as training sequences for at least one of the MIMO data streams, with the shape of the waveform as such conveying the training information.

22. A method for operating a network node in an EGPRS system, the method comprising receiving bursts from another node in the EGPRS system, where a burst comprises a training sequence with training information for use by the network node, the method comprising recognizing and using waveforms as training sequences in the bursts from the other node, and finding and extracting the training information in the shape of the waveforms as such.

23. The method of claim 22, according to which said waveforms are received as digital waveforms.

24. The method of claim 22, according to which said waveforms are received as analogue waveforms.

25. The method of claim 22, according to which said waveforms are received as non-modulated waveforms.

26. The method of claim 22, according to which said waveforms are received as chirps.

27. The method of claim 22, according to which said waveforms are received as waveforms with constant amplitude.

28. The method of claim 22, according to which a burst with a training sequence which is a waveform is used as an indication that the other node is transmitting two or more data streams in MIMO mode.
